(19) United States
(12) Patent Application Publication
(10) Pub. No.: US 2020/0387972 A1
(43) Pub. Date: Dec. 10, 2020

(54) Love (Break up) Insurance

(71) Applicant: Motoko Hazama, Ashiya (JP)

(72) Inventor: Motoko Hazama, Ashiya (JP)

(21) Appl. No.: 16/501,752

(22) Filed: Jun. 5, 2019

(51) Int. Cl. G06Q 40/08; G06Q 50/26

(52) U.S. Cl. CPC G06Q 40/08; G06Q 50/265

(57) ABSTRACT

This invention provides compensation for several of such losses as could be caused, when in the case of love unaccomplished, or when they fall by the wayside half way through, as much of their sincerity, hearts, or time put in there, or memories or chances of life lost during their engagement in love, by an insurance policy. And it also provides security for the legal enforcement of its implementation as well. Further, it provides the promotional effect for accomplishment of love by making the most of psychological motivation to prevent losses caused by the failure in love, when premiums are spent, and in addition, when it is chosen that the parties receive the optional repayments of a specified sum from the premium at the time it reaches a fixed period of time.

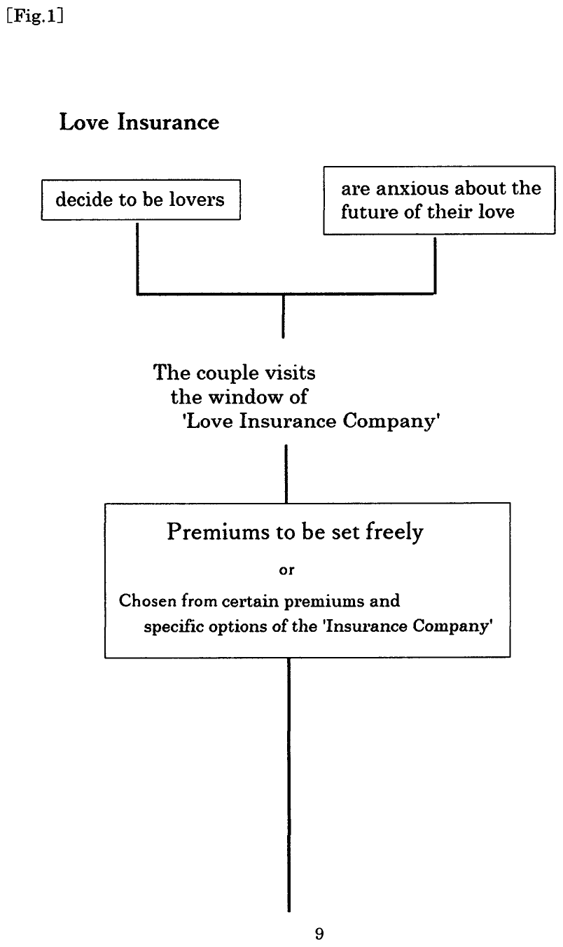

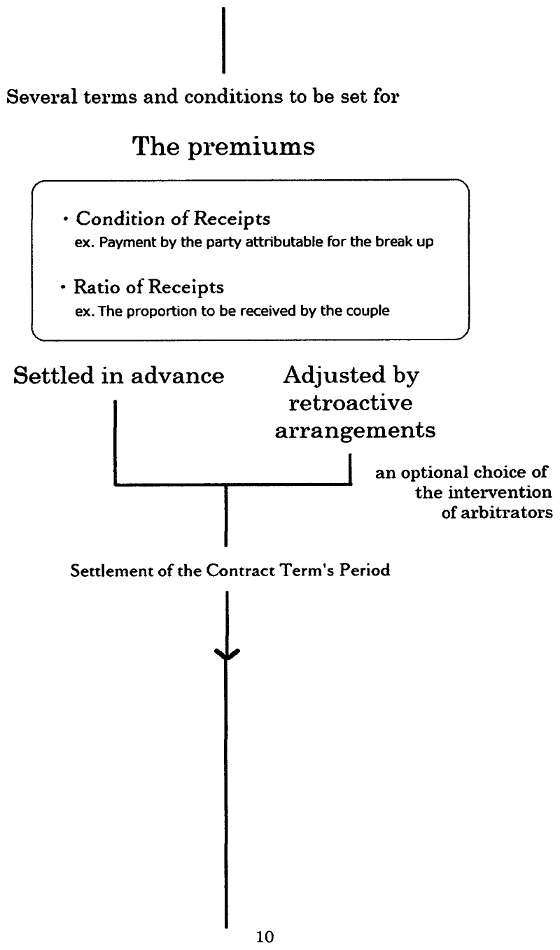

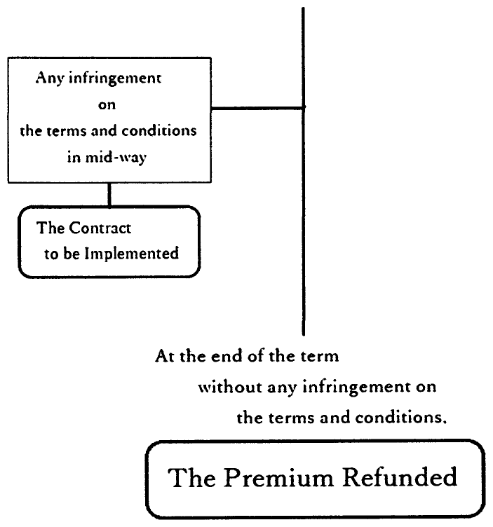

In short, this invention is about the conclusion of a contract, namely, purchase of the insurance policy. Specifically, it's about the settlements of several options, such as the premium sum and the amount receivable, or whether to receive it or not, the time of allowance, intervention of arbitrators, etc. Further, it stipulates the settlement for the conditions of receipt or the ratio of receptions of the premiums in advance, or the retroactive arrangements and adjustment of the percentages of receivable sum among the parties, considering several requisites.

And in addition to the effects above, my invention enables the assurance and confirmation of the identification of the other party of the love relation, through legitimate methods of verification and involvement of the authorized third party which is in most cases a company with an insurance operating license.

Moreover, when the love relationship of a couple falls wayside, bad emotion and foul temper often accompany the parties of love relation and their unsustainable fairness and equanimity of mind often make it difficult to impartially implement the stipulated terms and contracts in compliance. In this respect, the legal legitimacy and authorization of the contract renders validity and reinforcement to the viability and enforcement of the contract. And above all, whether utilizing electric medium for online-system or not, those aspects of my invention highly contribute to the isolation and removal of malicious deeds and results arising from love relations in sheer privacy without involvement of any third parties.

And in this sense, the method claim recites a series of acts for protecting lovers from relations containing malicious intention and deeds.

### TECHNICAL FIELD

### Business

### Background Art

‘Love (Break up) Insurance’ is the insurance to cover ‘Love’ that is a sort of gambles likened to be those with the results of ‘All or Nothing’, so to speak, one of the biggest events in our lives.

Much of sincerity and hearts, or time of both parties are put in there during engagement in love. And one could even lose the chances that could have been gained when he/she had chosen another distinct way from love at the crossroads of life.

‘Love (Break up) Insurance’ was devised to compensate several of those losses that could be caused when love wasn't accomplished, or when they fell by the wayside half way through.

The system is as explained in the followings. Where a couple visits foremost after they decided to be lovers, or a couple who are anxious about the antecedent and the future of their love is the window of ‘Love Insurance Company’. On registration, the couple has to submit copies of their identification cards or identity papers to verify their antecedents and the data must be checked against the original data as the identity verification process as part of the legitimate data management. As for the premiums, the contents of the premiums and terms and conditions of the contract are specified in [Claim 1]. Further, as for the conditions of receipt or the ratio of receptions of the premiums, they could also be settled in advance or adjusted by retroactive arrangements, by several terms and conditions, considering several requisites, such as to which party the break up is attributable, or if both parties are to blame, what are their proportions, etc.

There could also be an optional choice of the intervention of arbitrators.

Making further advance, when it is chosen on the contract that the parties receive the optional repayments of a specified sum from the premium at the time it reaches a fixed period of time, it increases in likelihood that both the parties of love hesitate and desist from immoralities and divorces, as the amount of refund gained afterward, and the amount of losses caused by betrayal being balanced against, it causes the sense of loss that serves as incentive for avoidance of those acts.

Also, when in the case of both parties of love inevitably leading to an end, the parties who were subjected to acts of disloyalty would be easier to accept much of their sincerity, hearts, or time put in there, or memories or chances of life lost during their engagement in love, in their own ways, putting the past behind them, by receiving certain amounts of compensation.

Thus, this Love (Break up) Insurance' is a very rational and considerate insurance policy which not only contributes to keeping good love to continue, but also contributes to filling up the sense of loss after the partings of couples. It could also be esteemed as a beneficial and significant policy which could also function as a social security system to promote the continuation of sound love.

It was precisely because the value of life and future of every individual was thoroughly considered that this ‘Love (Break up) Insurance’ was conceived.

As above, ‘Love (Break up) Insurance’ was developed.

### CITATION LIST

### Patent Literature

### Non Patent Literature

### SUMMARY OF INVENTION

Invention of an insurance policy named ‘Love (Break up) Insurance’.

### Technical Problem

Provision of compensation for several of such losses as could be caused, when in the case of love unaccomplished, or when they fall by the wayside half way through, as much of their sincerity, hearts, or time put in there, or memories or chances of life lost during their engagement in the love, by an insurance policy named ‘Love (Break up) Insurance’. And provision of security for the legal enforcement of its implementation as well. Further, provision of the promotional effect for accomplishment of love, by making the most of psychological motivation to prevent losses caused by the failure in love, especially when premiums are spent, and in addition, when it is chosen on the contract that the parties receive the optional repayment of a specified sum from the premium at the time it reaches a fixed period of time.

### Advantageous Effects of Invention

Provision of compensation for several of such losses as could be caused, when in the case of love unaccomplished, or when they fall by the wayside half way through, as much of their sincerity, hearts, or time put in there, or memories or chances of life lost during they were engaged in love, by an insurance policy named ‘Love (Break up) Insurance’. And provision of security for the legal enforcement of its implementation as well. Further, provision of the strengthening of awareness for accomplishment of love, gained when premiums are spent. And in addition, provision of increase in likelihood that both the parties of love hesitate and desist from immoralities and divorces, when it is chosen that the parties receive the optional repayment of a specified sum from the premium at the time it reaches a fixed period of time that causes the sense of loss and serves as incentive for avoidance of those acts, as the amount of refund gained afterward, and the amount of loss caused by betrayal being balanced against.

### BRIEF DESCRIPTION OF DRAWINGS

### Description of Embodiments

Conclusion of a contract of ‘Love (Break up) Insurance’, namely, purchase of the insurance policy. Specifically, the settlements of several options, such as the premium sum and the amount receivable, or whether to receive it or not, the time of allowance, intervention of arbitrators, etc. Further, the settlement for the conditions of receipt or the ratio of receptions of the premiums in advance, or the retroactive arrangements and adjustment of the percentages of receivable sum among the parties, considering several requisites along with terms and conditions.

### INDUSTRIAL APPLICABILITY

Sales and transaction of ‘Love (Break up) Insurance’ as an insurance policy at companies in the insurance industry.

### REFERENCE SIGNS LIST

1. ‘Love (Break up) Insurance’ system.

2. Several rules and options for ‘Love (Break up) Insurance’, such as the premium sum and the amount receivable, or whether to receive it or not, the percentages of receivable sum among the parties, the time of allowance, intervention of arbitrators, etc. and their settlements.

3. Settlements for the ratio of receptions of the premiums and the conditions of receipt for ‘Love (Break up) Insurance’ in advance. And likewise, the retroactive arrangements and adjustment of the percentages of receivable sum among the parties, considering several requisites along with terms and conditions.
